(19) United States
(12) Patent Application Publication
(10) Pub. No.: US 2002/0020411 A1
(43) Pub. Date: Feb. 21, 2002

(54) Slip resistant nasal occlusion device

(76) Inventor: Todd A. Resnick, Stuart, FL (US)

Correspondence Address: SMITH & HOPEN PA, 15950 BAY VISTA DRIVE, SUITE 220, CLEARWATER, FL, 33760

(21) Appl. No.: 09/682,759

(22) Filed: Oct. 15, 2001

Related U.S. Application Data
(63) Continuation-in-part of application No. 09/393,628, filed on Sep. 10, 1999, now Pat. No. 6,302,103.

(51) Int. Cl. A62B 18/08

(52) U.S. Cl. 128/201.18; 128/206.28; 128/897

(57) ABSTRACT

The present invention is a slip resistant nasal occlusion device for protective respirators including two suction cup pads and a clip connecting them together for biasing them against the sides of a wearer”s nose to occlude the nose wherein a vacuum is created by the engagement of the suction cup pads against the surface of the wearer”s nose. An alternative embodiment of the invention employs bioadhesive to engage and secure the noseclip from slipping off the nose.

### CONTINUTITY

This patent application is a Continuation in Part of U.S. patent application Ser. No. 09/393,628 originally filed Sep. 10, 1999.

### BACKGROUND OF INVENTION

1. Field of Invention

This invention relates to a nasal occlusion device, and more particularly to a device that resists slipping off the nose when wore under a respiratory protective hood.

2. Background of the Invention

Respiratory protective hoods are well known in the prior art. They typically comprise an air-impermeable enclosure sealed at the wearer's neck and fitted with a substantially transparent visor and breathing respirator.

Some respiratory protective hoods use a half-mask (aka “nose cup”) breathing interface. The half-mask seals around the wearer's nose and mouth area. However, a half-mask must be sized to accommodate the facial variations within a given population and a particular sized half-mask must be matched to the proper user. The inability of a hood with a half-mask to universally fit an adult population significantly complicates the logistics of protecting that same population. Another drawback of a hood with half-mask is the size and cost. These masks are difficult to store in a compact form. This hinders the portability and storage properties of the mask. Hoods with a half-mask utilize a significant amount of materials, thereby increasing their costs. Still another drawback to these designs is the pressure needed to keep the half-mask sealed to the face. Methods of applying pressure include placing tensioned straps around the head of the wearer. Properly adjusting these straps requires additional training and expends additional donning time in an emergency situation. Furthermore, the tension used to draw the mask to the face makes the design highly claustrophobic. The greater sealing area and the required tensioning system necessitate higher manufacturing costs, greater weight, greater bulk and more complexity in operation.

Many problems with the hood with half-mask are overcome by the use of a mouthpiece respirator. Mouthpiece respirators engaged by the wearer's mouth purify air drawn in through the oral pathway to the lungs by inhalation. The mouthpiece respirators also provide a pathway for exhalation. The mouthpiece respirator provides a number of distinct advantages over a hood with half-mask.

Mouthpiece respirators may be engaged and disengaged by the wearer while still wearing the protective hood. In addition, tension straps are not required when using the mouthpiece respirator as the support and seal to the air purifying means is provided by the wearer's mouth. This provides a marked level of control and comfort by the wearer.

Conversely, the wearer of a hood with half-mask suffers from continual pressure as the mask is pulled up against the face by tension in the straps.

An advantage of using a mouthpiece over a hood with half-mask is that of size. Mouthpiece respirators engage the oral cavity of the user while a half-mask must cover a significant area of the face. Accordingly, mouthpiece respirators are smaller and more compact while a hood with half-mask is larger and more bulky. This size difference also contributes to a lower manufacturing cost, better portability and easier storage for the mouthpiece design.

Another advantage of the mouthpiece respirator over a hood with half-mask is that of simplicity and speed. A hood with half-mask must be securely sealed against the face with a sufficient amount of pressure. If the amount of force is too little, leakage may occur, thereby lowering or negating the protection factor of the device. If the amount of force is too high, then the mask becomes too uncomfortable to wear. Some hoods with a half-mask utilize manual straps to adjust the tension level while other designs automatically provide a predetermined level of tension. Requiring the wearer to adjust manual straps in order to properly fit the hood requires significant training and repeated practice in order to assure the wearer is able to don the hood properly in an emergency situation. However, regardless of proficiency and skill, each adjustment step requires time in which the user may be subject to hazardous or even deadly conditions.

Designs that utilize a predetermined amount of tension to secure the mask risk being either uncomfortably tight or so loose that an effective seal is not obtained. It is important to note that an uncomfortable mask will likely be worn less than a comfortable mask. Tight-fitting masks may cause tissue soreness, claustrophobia, headaches and other ailments. A user suffering from these discomforts will not only become distracted from the tasks at hand, but will be more likely to remove the mask before it is safe to do so. Therefore, the comfort provided by the mouthpiece respirator has a direct and beneficial effect on the overall safety of the wearer and the ability of the wearer to maintain that safety level for extended periods of time. Nevertheless, a number of problems remain with current mouthpiece technology.

A significant problem with current mouthpiece designs is achieving and maintaining nasal occlusion. Protective hoods that utilize mouthpiece respirators will not function properly unless the nose is occluded. The wearer must not breath through his nose.

Nasal inhalation effectively bypasses the purification systems connected to the mouthpiece respirator, which greatly diminishes the protection factor of the protective hood. In addition, continued nasal inhalation produces a vacuum within the hood enclosure. This vacuum may lead to the introduction of outside, contaminated air into the enclosure.

Without nasal occlusion, nasal exhalation bypasses the mouthpiece respirator. This may lead to the accumulation of moisture and carbon dioxide-rich air within the ocular region of the hood. The cumulative effect of this process may fog the hood's visor and cause the hood to become uncomfortably hot.

In order to achieve nasal occlusion, prior art protective hoods generally utilize a noseclip comprising two opposing nostril pads biased towards each other. The wearer places the noseclip over his nose which is then pinched off. Additionally, outward extending fingers may extend from each nostril pad permitting the wearer to engage or disengage the noseclip from his nose.

When utilizing a noseclip with current protective hoods, the noseclip must be engaged before the protective hood is donned. Once the noseclip is in place, the wearer may then don the protective hood over his head. However, once the protective hood is placed over the wearer's head, the noseclip may slip off opening the nasal passage for respiration. This is a potentially dangerous situation for the wearer. If the wearer wishes to fix the noseclip to properly occlude the nose, he must break the airtight seal of the protective hood thereby exposing him to hazardous conditions.

To minimize the chance that the noseclip will slip off, increased pressure may be exerted by the nostril pads that occlude the nose. However, such pressure causes the wearer discomfort, particularly after periods of extended use. This is fundamentally expressed as the force required to overcome the friction equals the coefficient of friction between the sliding materials times the force or pressure exerted by gravity, or in this case, a resilient clip. Efforts have been made to increase the coefficient of friction such as U.S. Pat. No. 2,064,986 to Mezz. The '986 patent noted that corrugations, serrations or scorings may be employed to produce a friction grip to keep the noseclip from slipping (Col. 3, lines 24-28). U.S. Pat. No. 2,488,616 to Browne illustrates concentric rings on the surface of the noseclip pads that engage the nostrils (FIG. 1). However, none of the references in the prior art anticipate or suggest a method of providing an alternative to simply increasing the friction coefficient or the pressure applied.

Consequently, there is a need in the art for a noseclip that safely occludes the nose for extended periods of time, yet is still relatively comfortable for the wearer.

There is a further need in the art for a noseclip that applies the minimum amount of pressure needed to safely occlude the nose, but also is resistant to slipping off the nose.

However, in view of the prior art at the time the present invention was made, it was not obvious to those of ordinary skill in the pertinent art how the identified needs could be fulfilled.

### SUMMARY OF INVENTION

The present invention comprises a slip resistant nasal occlusion device for protective respirators having two suction cup pads and a clip connecting them together for biasing them against the sides of a wearer's nose to occlude the nose wherein a vacuum is created by the engagement of the suction cup pads against the surface of the wearer's nose. By creating an adhesive engagement by virtue of the vacuum effect of the suction cup pads, it is not necessary to increase the force of the clip to increase friction to prevent slippage. Rather, the minimum amount of force necessary to safely occlude the nose may be exerted by the noseclip. This produces a substantial increase in comfort to the wearer, particularly for extended use.

The suction cup pads may by pivotally attached to the clip wherein they may tilt freely relative to the clip to avoid discomfort. The clip itself is biased by a substantially resilient spring means which is preferably a thermoplastic material. A flat vacuum suction cup design may be employed for the suction cup pads. The flat design is typically designed to handle flat or slightly curved surfaces. They offer fast attach and release times due to their small internal volumes. Single bellows vacuum suction cups are ideal for engaging noses with uneven surfaces and irregular shapes. The bellows design compensates for nose irregularities and varied heights. They have longer attach and release times than flat cups and their spring action duplicates the function of mechanical springs in a much smaller and more economical package. Double bellows vacuum suction cups can accommodate even greater irregularities and height variations and uses lower vacuum levels. Accordingly, the suction cup pads may have one or more bellows.

An alternative embodiment of the invention comprises a threaded aperture on opposing sides of the clip, a screw member is axially fixed to each suction cup pad and threadably received by the apertures on the clip whereby rotation of the suction cup pads in a first direction engage the nose between the suction cup pads and rotation in a second direction disengage the nose between the suction cup pads. This embodiment enables the user to adjust the compression of the two opposing pads.

The suction cup pads are preferably constructed of durable, wear-resistant elastomeric material. Natural rubber has excellent wear resistance but poor oil and weather resistance. Nitrile, neoprene and vinyl all have good wear, oil and weather resistance. Silicon and urethane both have excellent wear, oil and weather resistance.

Silicone suction cups manufactured under the brand name ANVER SIT-2000 by ANVER Corporation of Hudson, Mass. are molded from a clear, translucent compound that is FDA Title 21 and the higher German Specification of GBVV (BGA) Part XV approved.

It contains no dyes that can leach out at temperatures up to 600° F. The cups are soft and pliable with a typical durometer reading of 60 depending upon thickness. VITON fluoroelastomer is well known for its excellent (400° F./200° C.) heat resistance. VITON offers excellent resistance to aggressive fuels and chemicals and has worldwide ISO 9000 registration. VITON is manufactured by DuPont Dow Elastomers, LLC based in Wilmington, Del.

An alternative to using a vacuum to create the adhesion of the noseclip pads to the nose may be achieved by employing bioadhesives. The slip resistant nasal occlusion device for protective respirators comprises two bioadhesive pads and a clip connecting them together for biasing them against the sides of a wearer's nose to occlude the nose.

An adhesion is created by the engagement of the bioadhesive pads against the surface of the wearer's nose. The actual bioadhesive material may comprise a number of different substances. Spirit gum is used often in the theatrical industry for gluing on beards and wigs. However, excessive perspiration may cause the spirit gum to crystallize and loosen.

Silicone-based adhesives, such as those sold under the brand name of KRYOLAN are stronger than spirit gum and faster drying. Often used for medical applications, siliconebased adhesives are also known to be more gentle to the skin than spirit gum. Another silicone-based adhesive is sold under the brand name of TELESIS made by Telesis Research Group of Pacoima, Calif., is a pressure-sensitive, silicone-based adhesive which is non-flammable. In a preferred embodiment, the bioadhesive is pre-applied to the noseclip pads. Accordingly a removable protective membrane is provided which is affixed to, and covers, the bioadhesive pads when not in use. Because the bioadhesive engagement of the nostrils prevents slippage, only the pressure necessary to occlude the nose is needed. Accordingly, the noseclip may be worn longer with more comfort and safety than noseclips described in the prior art.

It is therefore an object of the present invention to provide a protective respirator noseclip that does not slip, yet safely occludes the wearer's nose without excessive pressure.

It is to be understood that both the foregoing general description and the following detailed description are explanatory and are not restrictive of the invention as claimed.

The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is an isometric view of the noseclip according to the invention.

FIG. 2 is an isometric view of an embodiment of the noseclip having pivoting suction cup pads.

FIG. 3 is an isometric view of an embodiment of the noseclip having baffled suction cup pads.

FIG. 4 is an isometric view of an embodiment of the noseclip having bioadhesive pads.

FIG. 5 is an isometric view of an embodiment of the noseclip having screwably adjustable suction cup pads.

### DETAILED DESCRIPTION

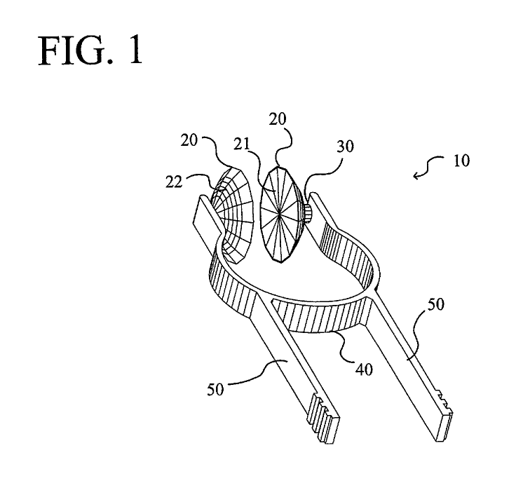

FIG. 1 shows the invention denoted as a whole by the numeral 10. Two suction cup pads 20 are biased together by a clip 40. The suction cup pads 20 may rotate about a connection 30 with the clip 40. An inner surface 21 of the suction cup pad 20 is concave and formed of a resilient elastomeric material wherein the engagement of the suction cup pad 20 to the nose of the wearer forces air out of the concave inner surface 27 thereby producing a vacuum. A convex outer surface 22 of the suction cup pad 20 may be rigidly or rotatably attached to the connection 30. Release fingers 50 may be depressed together to widen the distance between the two suction cup pads 20 during engagement or disengagement with the wearer's nose.

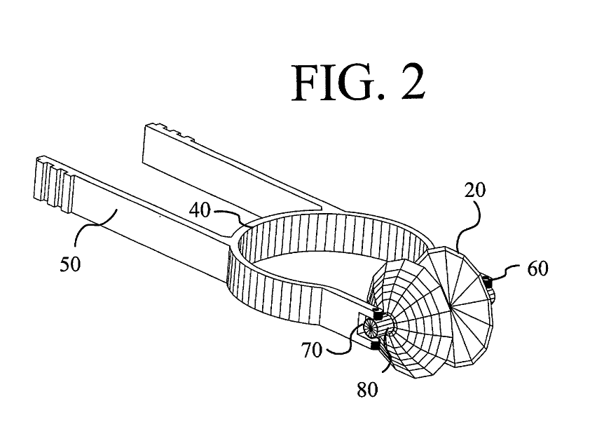

FIG. 2 shows an alternative embodiment of the invention wherein the suction cup pads 20 are pivotally attached to the clip 40. A notch may be formed in the ends of the clip 40 distal from the release fingers 50 wherein a pivot member 80 is received therein and secured by a pivot pin 60.

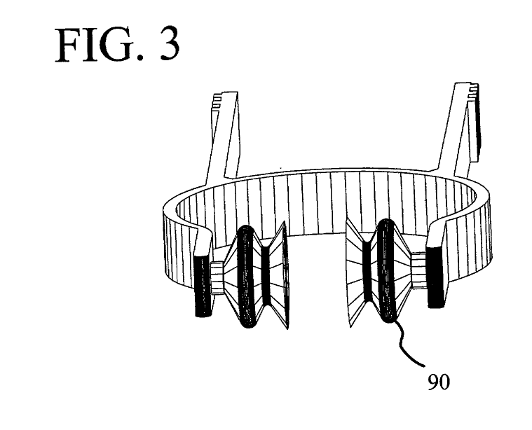

FIG. 3 shows another alternative embodiment of the invention having baffled suction cup pads 90. As described above in the Summary of Invention, baffled suction cups require less pressure and adapt to irregularities in the contact surface. Furthermore, the baffling of the elastomeric material provides a resilient “spring” effect that further enhances comfort by cushioning the point of contact. It should be noted that multiple baffles might also be employed.

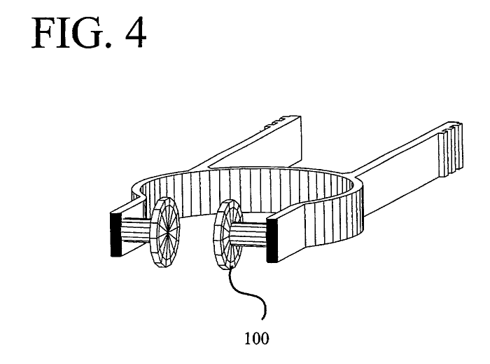

FIG. 4 shows another alternative embodiment of the invention employing bioadhesive pads 100 wherein the adhesion created by the engagement of the bioadhesive pads against the surface of the wearer's nose prevents slippage. As all bioadhesives are subject to drying out, a removable protective membrane covering may be affixed to the bioadhesive pads when not in use. This prevents the drying out of the substances, particularly those that are pressure-sensitive, silicone-based.

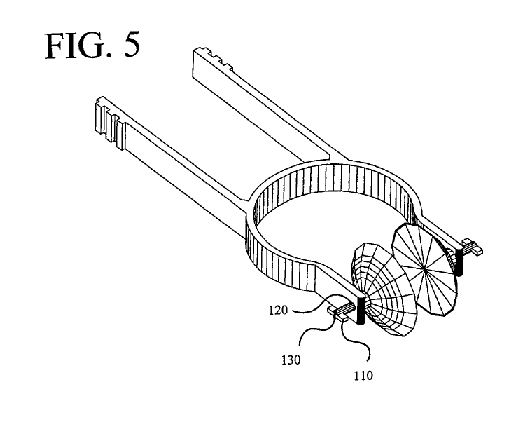

FIG. 5 shows another alternative embodiment of the invention wherein threaded apertures 120 on opposing sides of the clip 40 threadably receive screw members 130 fixed to each suction cup pad 20. The rotation of the suction cup pads in a first direction engages the nose between the suction cup pads and rotation in a second direction disengages the nose between the suction cup pads.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fail therebetween.

Now that the invention has been described,

1] a slip resistant nasal occlusion device for protective respirators comprising two suction cup pads and a clip connecting them together for biasing them against the sides of a wearer's nose to occlude the nose wherein a vacuum is created by the engagement of the suction cup pads against the surface of the wearer's nose:

2] The device of claim 1 wherein the two suction cup pads are pivotally attached to the clip.

3] The device of claim 1 wherein the clip is a biased by a substantially resilient spring means.

4] The device of claim 1 wherein the suction cup pads have one or more bellows.

5] The device of claim 1 further comprising a threaded aperture on opposing sides of the clip, a screw member axially fixed to each suction cup pad and threadably received by the apertures on the clip whereby rotation of the suction cup pads in a first direction engages the nose between the suction cup pads and rotation in a second direction disengages the nose between the suction cup pads.

6] The device of claim 1 wherein the suction cup pads are constructed of natural rubber.

7] The device of claim 1 wherein the suction cup pads are constructed of neoprene.

8] The device of claim 1 wherein the suction cup pads are constructed of silicone.

9] The device of claim 1 wherein the suction cup pads are constructed of urethane.

10] The device of claim 1 wherein the suction cup pads are constructed of vinyl.

11] The device of claim 1 wherein the suction cup pads are constructed of VITON.

12] The device of claim 1 wherein the suction cup pads are constructed of nitrile.

13] A slip resistant nasal occlusion device for protective respirators comprising two bioadhesive pads and a clip connecting them together for biasing them against the sides of a wearer's nose to occlude the nose wherein an adhesion is created by the engagement of the bioadhesive pads against the surface of the wearer's nose.

14] The device of claim 13 wherein the bioadhesive pad comprises spirit gum.

15] The device of claim 13 wherein the bioadhesive pad comprises a silicone-based adhesive composition.

16] The device of claim 13 further comprising a removable protective membrane covering affixed to the bioadhesive pads when not in use.

17] The device of claim 13 wherein the two bioadhesive pads are pivotally attached to the clip.

18] The device of claim 14 wherein the clip is a biased by a substantially resilient spring means.

19] The device of claim 14 further comprising a threaded aperture on opposing sides of the clip, a screw member axially fixed to each bioadhesive pad and threadably received by the apertures on the clip whereby rotation of the bioadhesive pads in a first direction engages the nose between the bioadhesive pads and rotation in a second direction disengages the nose between the bioadhesive pads.
